(19) United States
(12) Patent Application Publication
(10) Pub. No.: US 2002/0174175 A1
(43) Pub. Date: Nov. 21, 2002

(54) IP-based architecture for mobile computing networks

(75) Inventors: John Zhu, San Diego, CA (US); Michele Ann Jannette, Cardiff, CA (US)

Correspondence Address: John L. Rogitz, Rogitz & Associates, 750 B Street, Suite 3120, San Diego, CA, 92101, US

(73) Assignee: SONY CORPORATION, Tokyo (JP)

(21) Appl. No.: 09/840,328

(22) Filed: Apr. 23, 2001

(51) Int. Cl. G06F 15/16

(52) U.S. Cl. 709/203

(57) ABSTRACT

A wireless broadband IP network with a data transfer rate in excess of one megabyte per second for providing up to the minute subscription services to mobile client devices. The network has a network operation center (NOC) and base stations communicating with the NOC. Foreign agents at the base station communicate with a home agent at the NOC to identify client devices and grant client devices access to subscription services based on information stored at the NOC.

### RELATED APPLICATIONS

This application claims priority from U.S. provisional patent application serial No. 60/451,738, filed Dec. 5, 2000.

### BACKGROUND OF THE INVENTION

1. Field of the Invention

The present invention relates generally to wireless Internet Packet (IP) communication systems.

2. Description of the Related Art

Networked computing is a powerful tool for business and personal use. With it, the user of a user terminal that communicates with a network such as a company's local area network (LAN) can access and share data with other terminals in the network.

Most LANs are implemented by wired connections, i.e., by requiring that the computers in a network be attached to the network by means of wires. For convenience and to permit easy movement of user terminals within the network, wireless networks have been introduced, in which network communication is established via a wireless radiofrequency (rf) or infrared (IR) link.

As recognized by the present invention, a wireless communication network can be established using Internet Packet (IP) data format principles. In this way, data that is formatted for the Internet can be directly transmitted between a sender and a receiver. However, as also recognized herein, existing IP systems do not have a capability to recognize, at base stations, client devices on the network, or to maintain track of accounting data at base stations. The present invention understands that this renders such networks less than optimum for providing subscription services, such as wireless Internet subscription services, to client devices. Digital telephone systems, on the other hand, cannot be used for such purposes because, as understood herein, such systems have bandwidths that are too narrow to support broadband services as contemplated herein. Having recognized the above-noted problem, the present invention provides the solution disclosed herein.

### SUMMARY OF THE INVENTION

An Internet packet (IP) mobile wireless communication system includes a network operation center (NOC) that in turn includes a home domain having at least one associated home agent. Plural base stations communicate with the NOC, with each base station having at least one router and at least one foreign domain having at least one foreign agent. Also, client devices are in wireless IP communication with the base stations. With this invention, a base station detecting a client device uses its associated foreign agent to communicate an access request to the NOC.

In a preferred embodiment, each client device is assigned an IP address and each base station stores accounting data related to network access of a client device through the base station. The accounting data is sent to the NOC for correlation thereof to a client device registered at the NOC. The NOC can grant an access request when the client device associated with the request is registered at the NOC, with the NOC storing information relative to each client device registered at the NOC. When authentication is successful, the NOC sends an acknowledgement of an access request to a base station to grant an access request from the base station.

With the above system, mobile, up to the minute subscription services are provided to client devices by the NOC through the base stations. To this end, each router includes information to enable the router to recognize IP packets from foreign agents and home agents. The home agent informs foreign agents of types of client devices communicating on the system. If desired, the locations of the client devices can be tracked and subscription services provided thereto based on the location. Since a wireless IP network is envisioned, each client device includes a directional antenna and an IP transceiver electrically coupled to the antenna for communicating with the base stations.

In another aspect, a mobile wireless IP-based communication network for providing up to the minute subscription services to client devices includes a network operation center (NOC). Also, the network includes base stations communicating with the NOC and in wireless communication with client devices communicating with the network. The NOC provides subscription services to client devices via the base stations, and the base stations receive access authorizations from the NOC to permit client devices to communicate with the network. The base stations store accounting data based on client device usage of a base station.

In another aspect, a method for providing subscription services to client devices via a wireless network includes sending data to plural base stations, and transmitting the data in IP format to client devices that are in wireless communication with the base stations using a data transfer rate in excess of one megabyte per second.

The details of the present invention, both as to its structure and operation, can best be understood in reference to the accompanying drawings, in which like reference numerals refer to like parts.

### BRIEF DESCRIPTION OF THE DRAWINGS

FIG. 1 is a schematic diagram showing the system architecture of the present invention;

FIG. 2 is a flow chart showing the overall logic;

FIG. 3 is a flow chart showing the setup logic; and

FIG. 4 is a flow chart showing the operating logic.

### DETAILED DESCRIPTION OF THE PREFERRED EMBODIMENTS

Referring initially to FIG. 1, a system is shown, generally designated 10, that includes plural client devices or computers 12 (only a single device 12 shown for clarity) that is in wireless communication with one or more substantially identical, geographically separated base stations 14 of a wireless network 16. In one non-limiting embodiment, the network 16 can have a broadband Internet packet (IP) data protocol, such as an i-Burst network made by Arraycomm. Such a network can use space division multiple access (SDMA) directional communication principles and has a data transfer rate in excess of one megabyte per second, operating in a non-limiting, exemplary frequency of between two thousand three hundred million Hertz and two thousand three hundred ten million Hertz (2300 MHz-2310 MHz). Thus, the client device 12 includes an IP transceiver 12A with associated directional antenna 13. Each base station 14 likewise has a broadband IP transceiver 15. In turn, the base stations 14 communicate with a network operation center (NOC) 18 via wired or wireless communication paths.

The client device 12 can be any suitable portable device or PC. For example, the client device 12 can be a laptop or palmtop computer, or other network appliance, that contains a processor for executing the client-side logic herein. Likewise, the computers of the NOC 18 and base stations 14 can be portable computing devices, PCs, mainframe computers, or can themselves be networks of computers.

The flow charts herein illustrate the structure of a logic device of the present invention as embodied in computer program software. Those skilled in the art will appreciate that the flow charts illustrate the structures of logic elements, such as computer program code elements or electronic logic circuits, that function according to this invention. Manifestly, the invention is practiced in its essential embodiment by a machine component that renders the logic elements in a form that instructs a digital processing apparatus (that is, a computer) to perform a sequence of function steps corresponding to those shown. Internal logic could be as simple as a state machine.

In other words, the present logic may be established as a computer program that is executed by a processor as a series of computer-executable instructions. In addition to residing on hard disk drives, these instructions may reside, for example, in RAM of the appropriate computer, or the instructions may be stored on magnetic tape, electronic read-only memory, or other appropriate data storage device.

FIG. 1 also shows that the NOC 18 includes a network manager component 20, a customer care and billing (CCB) 22, and one or more home agents 24 for authenticating and authorizing access. If desired, each client device 12 that is registered can have its own home agent. The components 20, 22, 24 can be implemented by separate computers or by one computer.

The home agent component 24 contains authentication, authorization, and accounting information for its associated client or clients. Accordingly, the home agent component can include a software-implemented home agent that communicates with the below-described foreign agents at the base stations 14 regarding client device type, access authorization, and so on. In a non-limiting example, the home agent component 24 can be established by a conventional IP packet router computer programmed in accordance with the logic discussed herein.

In one non-limiting example, the network manager component 20 provides for monitoring the status of the network, including a database of authorized clients, types of software being used, operational status of the network, and so on. It can be a network manager component made by, e.g., Nortel, Hewlett-Packard, or Tivoli, although other types of network managers can be used. Also, the network manager component 20 can include sources of location-specific services as set forth in greater detail below.

In another non-limiting example, a conventional telephony or utility usage and billing computer can be used to establish the CCB component 22. For instance, an AMDOCS billing and usage computer can be used. The CCB component 22 tracks client usage of the network such that clients can be billed based on, e.g., air time, or on the number of IP packets communicated by the client over the network.

As shown in FIG. 1, each base station 14 has components that are analogous to those of the NOC 18. Specifically, each base station 14 includes a network manager component 26, a router 28, and a foreign domain 30 that is associated with a software-implemented foreign agent and that can be implemented by the router 28 if desired. That is, the components 26, 28, 30 can be implemented in separate computers or in a single computer.

The router 28 includes software that recognizes IP packets from foreign agents and home agents. Thus, the router 28 can “discover” a new device 12 on the network by recognizing its transmissions in the form of IP. Also, a client device 12 can communicate, via the client and base station transceivers 12A, 15, with the foreign agent resident at the foreign domain 30 as disclosed in greater detail below.

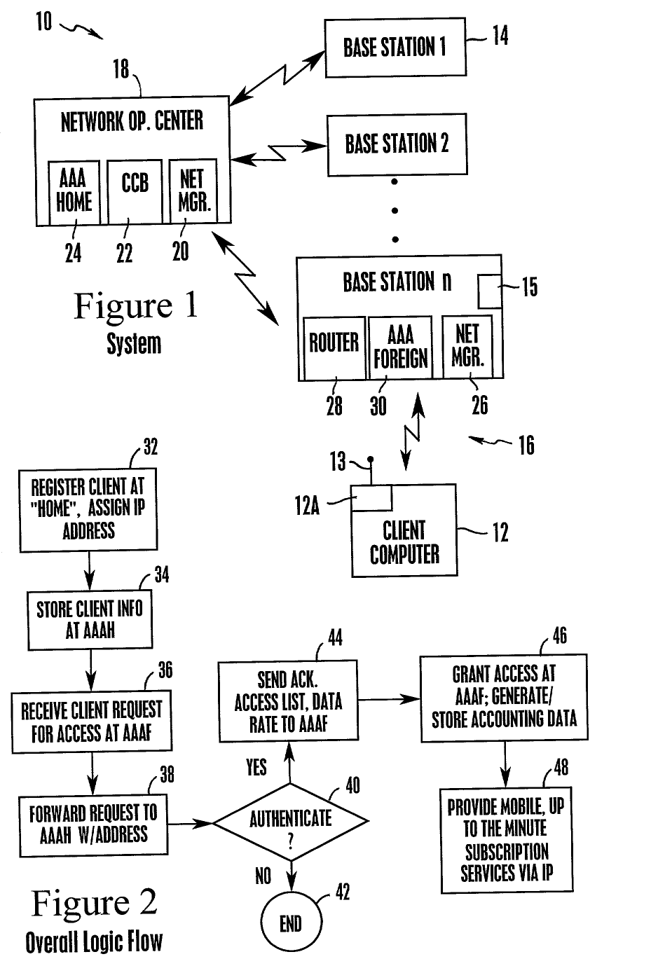

More particularly, referring to FIG. 2, at block 32 each client device 12 to which it is desired to give network access is assigned a respective IP address and is registered at the home domain 24 at the NOC 18. Registration can include device type, owner identification and profile, and billing information. This client information is stored, at block 34, at the home domain 24.

When a mobile client device 12 wishes to communicate with the network, it sends a client request for access at block 36. The router 28 of the nearest base station 14 or base station 14 receiving the strongest client device 12 signal recognizes the signal from the client device, if not the precise identity of the client. In other words, when the requesting client device is a “foreign” device as to the particular base station 14 with which it is communicating, network routing and communication nevertheless are provided as set forth below.

The IP address of the client device 12 is combined, e.g., by concatenation, with the identification of the foreign agent of the foreign domain 30 of the receiving base station 14. At block 38, the request for access, along with or consisting of the combined client device 12/foreign agent identification, is sent to the home agent of the home domain 24.

The home agent, at decision diamond 40, accesses its client information that is stored at the NOC 18 to determine whether the requesting client is authorized network access, and if so, of what type. If access is not authorized, the logic ends at state 42. Otherwise, the logic proceeds to block 44, wherein the home agent transmits an acknowledgement of authorization, along with an access list, to the foreign agent at the base station 14. The access lists informs the foreign agent of the types of subscription services that can be provided to the particular client device 12.

At block 46, the appropriate level of network access is granted to the client device 12. In doing this, the router 28 of the base station communicating with the requesting client device adds a temporary “care” address line in its access list for the foreign client, such that the router 28, although a “foreign” router vis-a-vis the requesting client device, can undertake all routing of IP packets from the requesting client device for the communication session. As the client device 12 accesses the network via a base station 14, accounting data, such as length of access time and type of network access, subscription services used, etc. are stored at the respective base station 14. Mobile, up to the minute subscription services can be provided to the client device 12 at block 48 in accordance with the client information stored at the home domain 24.

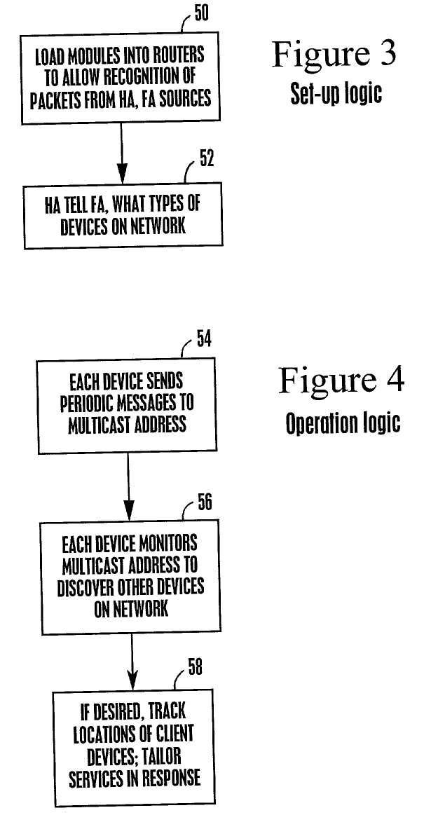

FIG. 3 shows the logic for setting up the system 10. Commencing at block 50, modules are loaded into the routers 28 of the base stations 14 to allow the base stations 14 to recognize IP packets from home agent and foreign agent sources. At block 52, home agents inform foreign agents as to what types of client devices 12 might be expected to be on the network.

FIG. 4 shows certain details of the operation logic. Commencing at block 54, once connected, a client device 12 can periodically send messages of its location and/or status to a system multicast address, e.g., the IP address of the NOC 18. At block 56, each client device 12 can monitor the multicast address using the network to discover other client devices on the network, to establish communication with the other devices if desired using the network. Based on, e.g., signal directionality determinations from triangulating base station 14 receptions, the locations of the client devices 12 can be determined at block 58 and certain subscription services, such as microweather reports, can be tailored in response by the network manager component 20 (FIG. 1).

While the particular IP-BASED ARCHITECTURE FOR MOBILE COMPUTING NETWORKS as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular means “at least one”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. §112, sixth paragraph, unless the element is expressly recited using the phrase “means for”.

What is claimed is:

1. An Internet packet (IP) mobile wireless communication system, comprising:
at least one network operation center (NOC) including at least one home domain having at least one associated home agent;
plural base stations communicating with the NOC, each base station having at least one router and at least one foreign domain having at least one foreign agent; and
plural client devices in wireless IP communication with at least one base station, whereby a base station detecting a client device uses its associated foreign agent to communicate at least one access request to the NOC.

2. The system of claim 1, wherein each client device is assigned an IP address and each base station stores accounting data related to network access of a client device through the base station.

3. The system of claim 2, wherein the accounting data is sent to the NOC for correlation thereof to a client device registered at the NOC.

4. The system of claim 1, wherein the NOC grants an access request when the client device associated with the request is registered at the NOC.

5. The system of claim 1, wherein the NOC stores information relative to each client device registered at the NOC.

6. The system of claim 4, wherein the NOC sends an acknowledgement of an access request to a base station to grant an access request from the base station.

7. The system of claim 1, wherein mobile, up to the minute subscription services are provided to at least one client device by the NOC through at least one base station.

8. The system of claim 1, wherein each router includes information to enable the router to recognize IP packets from foreign agents and home agents.

9. The system of claim 1, wherein the home agent informs foreign agents of types of client devices communicating on the system.

10. The system of claim 1, wherein a location of at least one client device is tracked and subscription services provided thereto based at least partially on the location.

11. The system of claim 1, wherein each client device includes a directional antenna and an IP transceiver electrically coupled to the antenna for communicating with the base stations.

12. A mobile wireless IP-based communication network for providing up to the minute subscription services to client devices, comprising:
at least one network operation center (NOC); and
plural base stations communicating with the NOC and in wireless communication with client devices communicating with the network, the NOC providing subscription services to client devices via the base stations, the base stations receiving access authorizations from the NOC to permit client devices to communicate with the network, the base stations storing at least some accounting data based on client device usage of a base station.

13. The network of claim 12, wherein the NOC includes at least one home domain having at least one associated home agent and each base station has at least one router and at least one foreign domain having at least one foreign agent.

14. The network of claim 13, wherein each client device is assigned an IP address and each base station stores accounting data related to network access of a client device through the base station.

15. The network of claim 14, wherein the accounting data is sent to the NOC for correlation thereof to a client device registered at the NOC.

16. The network of claim 13, wherein the NOC grants an access request when the client device associated with the request is registered at the NOC.

17. The network of claim 13, wherein the NOC stores information relative to each client device registered at the NOC.

18. The network of claim 16, wherein the NOC sends an acknowledgement of an access request to a base station to grant an access request from the base station.

19. The network of claim 13, wherein each router includes information to enable the router to recognize IP packets from foreign agents and home agents.

20. The network of claim 13, wherein the home agent informs foreign agents of types of client devices communicating on the network.

21. The network of claim 13, wherein a location of at least one client device is tracked and subscription services provided thereto based at least partially on the location.

22. The network of claim 12, wherein the network has a data transmission rate between a client device and a base station in excess of one megabyte per second.

23. The system of claim 1, wherein the system has a data transmission rate between a client device and a base station in excess of one megabyte per second.

24. A method for providing subscription services to client devices via a wireless network, comprising:
sending data to plural base stations; and
transmitting the data in IP format to at least one client device in wireless communication with at least one base station using a data transfer rate in excess of one megabyte per second.

25. The method of claim 24, further comprising using a foreign agent at a base station to communicate with a home agent associated with a network operation center (NOC) to establish access to a wireless network such that the data can be received by a client device.

26. The method of claim 25, further comprising combining an IP address of a client device with a name of a foreign agent to render a combination and sending the combination to the NOC.

27. The method of claim 26, wherein the NOC uses the combination to determine whether to grant access to the associated client device.

28. The method of claim 27, further comprising permitting a first client device to communicate with a second client device via at least one base station.

29. The method of claim 24, further comprising storing at least some accounting data related to client device access at least one base station.

30. The method of claim 24, further comprising tracking a location of at least one client device, and tailoring the subscription services in response thereto.
